(19) United States
(12) Patent Application Publication
(10) Pub. No.: US 2006/0293413 A1
(43) Pub. Date: Dec. 28, 2006

(54) Pigment pastes containing effect pigments, method for the production thereof, and use thereof

(76) Inventor: Gotz-Ekkehard Sapper, 88339 Bad Waldsee (DE)

Correspondence Address: BASF CORPORATION, 1609 BIDDLE AVENUE, WYANDOTTE, MI, 48192, US

(21) Appl. No.: 10/595,192

(22) PCT Filed: Oct. 19, 2004
(86) PCT No.: PCT/EP04/52814

§ 371 Date: Mar. 28, 2006

(30) Foreign Application Priority Data
Oct. 30, 2003 (DE) 10350719.1

(51) Int. Cl. C09D 5/29

(52) U.S. Cl. 523/171

(57) ABSTRACT

Effect pigment pastes include at least one effect pigment; at least one aqueous monomodal primary dispersion which is pseudoplastic after neutralization and has a solids content of from 15 to 40% by weight, comprising as disperse phase particles with an average size of from 10 to 500 nm which are composed of a hydrophobic core and hydrophilic shell, said particles being constructed of at least one (meth)acrylate copolymer having a glass transition temperature of from 30 to 100° C. and an acid number of from 10 to 50 mg KOH/g; at least one organic amine and/or ammonia; nonionic surfactant; and organic solvent, process for preparing the pigment paste, and their use for preparing pigmented mixtures, especially aqueous and nonaqueous coating materials.

The present invention relates to novel effect pigment pastes (i.e., pigment pastes comprising effect pigments). The present invention further relates to a novel process for preparing effect pigment pastes. The present invention additionally relates to the use of the novel effect pigment pastes and of the effect pigment pastes prepared by means of the novel process particularly for preparing aqueous or nonaqueous, especially aqueous, coating materials.

The use of effect pigments in aqueous coating materials, such as waterborne basecoats, and nonaqueous coating materials has been known for a long time.

Because of their comparatively high sensitivity to mechanical exposure, effect pigments cause problems when incorporated into aqueous coating materials, especially waterborne basecoats. In the preparation of a metallic waterborne basecoat, for example, it is necessary to mix the effect pigments in the form of a paste or suspension in a liquid organic phase with the remaining ingredients of the waterborne basecoat.

For this purpose the effect pigments are normally dispersed or pasted in organic solvents with or without binding resins. As solvents it is usual to use an organic solvent or solvent mixture which effectively wets the effect pigment. Additionally, polyesters are normally used as binding resins (cf., for example, the Akzo Nobel Resins brochure “Starting Point Formulation based on Setalux® 6802 AQ-24”, dated Feb. 23, 2001). The nature of such pasting has a substantial influence on the quality of the effects of the coatings produced by means of the coating materials in question.

The existing nonaqueous effect pigment pastes, however, have the drawback of having only a very limited storage life, of not more than a few days. After that time the effect pigments settle and inhomogeneities and coagulum are formed. Aqueous coating materials, especially waterborne basecoats, and nonaqueous coating materials prepared using these pigment pastes provide coatings only of relatively low optical quality.

For industrial coating on the line at the automaker's plant as well the inadequate storage life of the known nonaqueous effect pigment pastes is a major problem. Thus these pigment pastes cannot be produced in sizeable amounts for holding in stock, although this would be desirable on economic grounds. The transportability of the pastes also leaves much to be desired. As a result, the possibility of preparing the pigment pastes at one production site with optimum production conditions and transporting them to the customers is also absent. Moreover, for the aftertinting of waterborne basecoats, for example, especially metallic waterborne basecoats, the pigment pastes have to be prepared anew each time.

Akzo Nobel Resins' “Setalux® 6802 AQ-24” brochure of January 2000 discloses an aqueous primary dispersion of a (meth)acrylate copolymer. The primary dispersion has a solids content of from 22 to 26% by weight and an acid number (as such) of from 3.5 to 5.2 mg KOH/g. The size of the (meth)acrylate copolymer particles is from 180 to 255 nm. Following its neutralization, the primary dispersion is pseudoplastic. It brings about effective orientation of aluminum effect pigments in waterborne basecoat materials. It is highly stable, insoluble in organic solvents, and readily atomizable. According to the Akzo Nobel Resins brochure “Starting Point Formulation based on Setalux® 6802 AQ-24” of Feb. 23, 2001 this primary dispersion or the (meth)acrylate copolymer it comprises is used as a binder in waterborne metallic basecoat materials. The waterborne metallic basecoat materials are prepared by mixing the solution of a melamine-formaldehyde resin, a conventional pigment paste composed of an aluminum effect pigment, butyl glycol, a polyester, and dimethylethanolamine, the solution of the polyester in butyl glycol, and dimethylethanolamine with a large amount of primary dispersion and water. Hence the use of the primary dispersion for preparing pigment pastes comprising aluminum effect pigment is not described.

It is an object of the present invention to provide novel effect pigment pastes which no longer have the disadvantages of the prior art but which instead can be prepared stably, storably, transportably, and without damage to the effect pigments, in a simple way. Preferably the novel effect pigment pastes ought to be storable for long periods (up to 3 months, for example) without sedimentation and without the formation of inhomogeneities or coagulum.

The novel effect pigment pastes ought to be able to be produced at a production site that offers optimum conditions and transported to the customers, in particular to the automakers. In this way the intention is that the expense and inconvenience involved in keeping stocks should be significantly reduced. Moreover, the novel effect pigment pastes ought to be able easily to withstand shearing in the circuits of the coating plants without being damaged.

The novel effect pigment pastes ought to allow the preparation of storable, transportable aqueous coating materials, especially waterborne basecoat materials, and nonaqueous coating materials which are stable in shade, stable in effect, and easy to apply, and which give outstanding color and/or effect coating systems, especially multicoat paint systems, of automobile quality (on this point, see also European patent EP 0 352 298 B1, page 15 line 42 to page 17 line 40).

The novel effect pigment pastes ought not least to be compatible with as wide as possible a spectrum of pigments without requiring substantial modification to their composition.

The invention accordingly provides the novel effect pigment pastes preparable from at least the following constituents:
(A) from 10 to 65% by weight of at least one effect pigment,
(B) from 1 to 20% by weight of at least one aqueous monomodal primary dispersion which is pseudoplastic after neutralization and has a solids content of from 15 to 40% by weight, comprising as disperse phase particles with an average size of from 10 to 500 nm which are composed of a hydrophobic core and hydrophilic shell, said particles being constructed of at least one (meth)acrylate copolymer having a glass transition temperature of from 30 to 100° C. and an acid number of from 10 to 50 mg KOH/g,
(C) from 0.01 to 2% by weight of at least one organic amine and/or ammonia,
(D) from 0.1 to 3.0% by weight of at least one nonionic surfactant, and
(E) at least 10% by weight of an organic solvent,
   the percentages being based in each case on the total amount of a pigment paste.

The novel effect pigment pastes are referred to below as “pigment pastes of the invention”.

The invention further provides the novel process for preparing effect pigment pastes, which involves mixing at least
(A) from 10 to 65% by weight of at least one effect pigment,
(B) from 1 to 20% by weight of at least one aqueous monomodal primary dispersion which is pseudoplastic after neutralization and has a solids content of from 15 to 40% by weight, comprising as disperse phase particles with an average size of from 10 to 500 nm which are composed of a hydrophobic core and hydrophilic shell, said particles being constructed of at least one (meth)acrylate copolymer having a glass transition temperature of from 30 to 100° C. and an acid number of from 10 to 50 mg KOH/g,
(C) from 0.01 to 2% by weight of at least one organic amine and/or ammonia,
(D) from 0.1 to 3.0% by weight of at least one nonionic surfactant, and
(E) at least 10% by weight of an organic solvent,
   the percentages being based in each case on the total amount of a pigment paste, with one another and homogenizing the resultant mixture.

The novel process for preparing effect pigment pastes is referred to below as “process of the invention”.

The invention additionally provides for the novel use of the pigment pastes of the invention for preparing aqueous and nonaqueous coating materials, which is referred to below as “use in accordance with the invention”.

In the light of the prior art it was surprising and unforeseeable for the skilled worker that the object on which the present invention was based could be achieved by means of the pigment pastes of the invention, the process of the invention, and the use in accordance with the invention, without the occurrence of the disadvantages, depicted at the outset, of the prior art.

The pigment pastes of the invention were simple to prepare without damage to the pigments. Additionally, only comparatively small amounts of additives were needed. Despite this the pigment pastes of the invention were surprisingly stable, transportable, and storable A particular surprise was that the pigment pastes of the invention were storable for several months without settling and without the formation of inhomogeneities or coagulum.

The pigment pastes of the invention could therefore be prepared at a production site offering optimum conditions, and transported to the customers, especially the automakers. In this way it was possible to achieve significant reduction in the expense and inconvenience involved for the customer in holding stocks. Moreover, the pigment pastes of the invention were able to undergo shearing in the circuits of the coating plants without problems and without being damaged.

Surprisingly, the pigment pastes of the invention gave storable, transportable, aqueous coating materials, especially waterborne basecoat materials, and nonaqueous coating materials which were stable in shade, stable in effect, and easy to apply.

The waterborne basecoat materials made it possible to produce outstanding multicoat effect, or color and effect, paint systems of automobile quality. According to European patent EP 0 352 298 B1, page 15 line 42 to page 17 line 14, this means that the multicoat paint systems in question scored highly for

(1) gloss,

(2) distinctiveness of image,

(3) extent and uniformity of hiding power,

(4) uniformity of dry film thickness,

(5) gasoline resistance,

(6) solvent resistance,

(7) acid resistance,

(8) hardness,

(9) abrasion resistance,

(10) scratch resistance,

(11) impact strength,

(12) intercoat and substrate adhesion, and

(13) weathering stability and UV resistance.

Additionally it was particularly surprising that the pigment pastes of the invention could be used for the corresponding nonaqueous coating materials as well, without any need to modify their formula.

A further surprise was that the pigment pastes of the invention could be prepared with a multiplicity of effect pigments.

The pigment pastes of the invention comprise at least one effect pigment (A) in an amount, based on the pigment paste, of from 10 to 65% by weight, preferably from 15 to 60% by weight, and in particular from 20 to 55% by weight.

This, therefore, is a pigment concentration which is far higher than the pigment concentration commonly present in the coating materials prepared from the corresponding pigment pastes. This high concentration is the essential feature of a pigment paste.

The effect pigments (A) are preferably selected from the group consisting of organic and inorganic, optical effect, color and optical effect, magnetically shielding, electrically conductive, anticorrosion, fluorescent, and phosphorescent pigments, more preferably from the group consisting of organic and inorganic, optical effect, and color and optical effect pigments, and in particular from the group consisting of metal effect pigments, effect pigments composed of metals and nonmetals, and nonmetallic effect pigments.

In particular the metal effect pigments (A) are aluminum effect pigments, iron effect pigments or copper effect pigments, such as commercial aluminum bronzes, aluminum bronzes chromated in accordance with DE 36 36 183 A1, commercial stainless steel bronzes, and commercial copper bronzes.

In particular the effect pigments (A) composed of metals and nonmetals are platelet-shaped aluminum pigments coated with iron oxide, as described for example in European patent application EP 0 562 329 A2; glass flakes coated with metals, especially aluminum; or interference pigments which comprise a reflector layer of metal, especially aluminum, and exhibit a strong color flop, as described for example in American patents U.S. Pat. No. 4,434,010 A1, U.S. Pat. No. 4,704,356 A1, U.S. Pat. No. 4,779,898 A1, U.S. Pat. No. 4,838,648 A1, U.S. Pat. No. 4,930,866 A1, U.S. Pat. No. 5,059,245 A1, U.S. Pat. No. 5,135,812 A1, U.S. Pat. No. 5,171,363 A1 or U.S. Pat. No. 5,214,530 A1.

The nonmetallic effect pigments (A) are in particular pearlescent pigments, especially mica pigments, as described for example in Merck Kontakte, 1992, No. 2, pages 3 to 60; platelet-shaped graphite pigments coated with metal oxides, as described for example in Japanese patent application JP 5-311098 A; interference pigments which contain no metal reflector layer but exhibit a strong color flop, as described for example in American patents U.S. Pat. No. 4,434,010 A1, U.S. Pat. No. 4,704,356 A1, U.S. Pat. No. 4,779,898 A1, U.S. Pat. No. 4,838,648 A1, U.S. Pat. No. 4,930,866 A1, U.S. Pat. No. 5,059,245 A1, U.S. Pat. No. 5,135,812 A1, U.S. Pat. No. 5,171,363 A1 or U.S. Pat. No. 5,214,530 A1, platelet-shaped effect pigments based on iron oxide with a shade ranging from pink to brownish red, as described for example in patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A or U.S. Pat. No. 5,244,649 A; or organic, liquid-crystalline effect pigments.

For further details refer to Römpp Lexikon Lacke und Druckfarben, Georg Thieme Verlag, 1998, page 176, “effect pigments” and pages 380 and 381, “metal oxide-mica pigments” to “metal pigments”.

Examples of fluorescent and phosphorescent pigments (daylight-fluorescent pigments) are bis(azomethine) pigments.

Examples of suitable electrically conductive pigments are titanium dioxide/tin oxide pigments and pulverulent metal pigments.

Examples of magnetically shielding pigments are pigments based on iron oxides or chromium dioxide.

Examples of suitable anticorrosion pigments are zinc powders, lead silicates, zinc phosphates or zinc borates.

Consequently, on the basis of the multiplicity of suitable effect pigments (A), the pigment pastes of the invention ensure a universal scope for application and allow the preparation of coating materials of the invention which can be used to produce an extremely wide diversity of coatings having any of a very wide variety of physical effects.

The pigment pastes of the invention may further comprise at least one pigment other than the metal pigments (A), selected from the group consisting of organic and inorganic, color and extender pigments, pigments having at least two of these properties, and nanoparticles, provided such an additional pigment does not adversely affect the performance properties of the pigment pastes of the invention.

Examples of suitable inorganic color pigments are white pigments such as zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spine phases and corundum phases or chromium orange; or yellow iron oxide, nickel titanium yellow, chromium titanium yellow, cadmium sulfide, cadmium zinc sulfide, chromium yellow or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details refer to Römpp Lexikon Lacke und Druckfarben, Georg Thieme Verlag, 1998, pages 180 and 181, “iron blue pigments” to “black iron oxide”, pages 451 to 453, “pigments” to “pigment volume concentration”, page 563, “thioindigo pigments”, page 567, “titanium dioxide pigments”, pages 400 and 467, “naturally occurring pigments”, page 459, “polycyclic pigments”, page 52, “azomethine pigments”, “azo pigments”, and page 379, “metal complex pigments”.

Examples of suitable extender pigments or fillers are chalk, calcium sulfate, barium sulfate, silicates such as talc or kaolin, silicas, oxides such as aluminum hydroxide or magnesium hydroxide or organic fillers such as textile fibers, cellulose fibers, polyethylene fibers or polymer powders; for further details refer to Römpp Lexikon Lacke und Druckfarben, Georg Thieme Verlag, 1998, pages 250 ff., “fillers”.

The nanoparticles are preferably selected from the group consisting of main group and transition group metals and their compounds. Preference is given to the main group and transition group metals selected from metals of main groups three to five, transition groups three to six, and transition groups one and two of the periodic table of the elements, and from the lanthanides. Particular preference is given to using boron, aluminum, gallium, silicon, germanium, tin, arsenic, antimony, silver, zinc, titanium, zirconium, hafnium, vanadium, niobium, tantalum, molybdenum, tungsten, and cerium, especially aluminum, silicon, silver, cerium, titanium, and zirconium. The compounds of the metals are preferably the oxides, oxide hydrates, sulfates or phosphates. Preference is given to using silver, silicon dioxide, aluminum oxide, aluminum oxide hydrate, titanium dioxide, zirconium oxide, cerium oxide, and mixtures thereof, with particular preference silver, cerium oxide, silicon dioxide, aluminum oxide hydrate, and mixtures thereof, very preferably aluminum oxide hydrate and especially boehmite. The nanoparticles preferably have a primary particle size <50 nm, more preferably from 5 to 50 nm, in particular from 10 to 30 nm.

In accordance with the invention the pigment pastes of the invention are preparable using at least one, especially one, aqueous monomodal primary dispersion (B) which is pseudoplastic following neutralization, said dispersion being used in an amount, based on the pigment dispersion of the invention, of from 1 to 20% by weight, preferably from 2 to 18% by weight, and in particular from 5 to 15% by weight.

The primary dispersion (B) has a solids content of from 10 to 40% by weight, preferably from 10 to 35% by weight, and in particular from 15 to 30% by weight.

The primary dispersion (B) comprises as disperse phase particles having an average size of from 10 to 500 nm, preferably from 50 to 400 nm and in particular from 100 to 300 nm. The particle sizes are preferably situated in the range from 50 to 450 nm, more preferably from 80 to 400 nm and in particular from 100 to 300 nm.

The particles have a hydrophobic core and hydrophilic shell. The property of being hydrophobic refers to the constitutional property of a molecule or functional group to behave exophilically with respect to water; that is, it displays the tendency not to penetrate water or else to depart the aqueous phase. Conversely, a hydrophilic molecule or functional group displays the constitutional property of behaving exophilically with respect to an apolar, hydrophobic phase; that is, it exhibits the tendency to penetrate water or to depart the apolar phase (cf. also Römpp Lexikon Lacke und Druckfarben, Georg Thieme Verlag, Stuttgart, New York, 1998, “hydrophilicity”, “hydrophobicity”, pages 294 and 295).

The particles form substantially all, preferably more than 80% by weight, in particular more than 90% by weight, based in each case on the solids, or all of the solids of the dispersion of the invention.

The particles are composed of at least one, especially one, (meth)acrylate copolymer. In other words the particles consist essentially, preferably more than 80% by weight, in particular more than 90% by weight, based in each case on the particles, or completely of the (meth)acrylate copolymer(s).

The (meth)acrylate copolymer has a glass transition temperature of from 30 to 100° C., preferably from 35 to 90° C., and in particular from 40 to 80° C. (measured by means of Differential Scanning Calorimetry (DSC)) and an acid number of from 10 to 50 mg KOH/g, and preferably from 10 to 40 mg KOH/g.

The (meth)acrylate copolymer preferably contains reactive functional groups, as are described, for example, in the overview in German patent application DE 199 30 067 A1, page 7 line 25 to page 8 line 59. In particular it contains hydroxyl groups.

The (meth)acrylate copolymer contains in copolymerized form conventional (meth)acrylates and optionally different, conventional, olefinically unsaturated monomers. The selection of the (meth)acrylates and of the optionally different, olefinically unsaturated monomers is made so as to result in the above-described profile of properties of the (meth)acrylate copolymers Examples of suitable (meth)acrylates and optionally different, olefinically unsaturated monomers, and of the rules for their selection, are known from German patent application DE 197 25 188 A1, page 3 line 4 to page 4 line 38.

Use is made in particular of one or more (meth)acrylates selected from the group consisting of methyl methacrylate, n-butyl acrylate, hydroxyethyl methacrylate, n-butyl methacrylate, acrylic acid, and methacrylic acid.

The (meth)acrylate copolymer is prepared by means of conventional free-radical emulsion copolymerization processes in aqueous phase, so that the primary dispersion to be used in accordance with the invention is obtained directly.

The primary dispersion (B) is pseudoplastic. This means that it has a viscosity which changes sharply as a function of its shearing; if subjected to strong shearing, the viscosity falls; when shearing is no longer applied, the viscosity rises again.

The primary dispersion (B) preferably has a viscosity of from 0.1 to 0.13 Pas at a shear rate of less than 100/s and from 0.07 to 0.08 Pas at a shear rate of approximately 1000/s (measured in a shear-rate-controlled rotational viscometer RFSII at 23° C.; cylinder geometry: cup diameter 34 mm; cylinder diameter 32 mm; cylinder length 36.35 mm; Couette geometry, DIN 53018).

The primary dispersion (B) develops this pseudoplasticity following its neutralization by means of said at least one organic amine and/or ammonia (C).

Very particular preference is given to using a primary dispersion (B) which is sold by Akzo Nobel Resins under the brand name SETALUX® 6802 AQ 24.

The pigment pastes of the invention contain, based on their total amount, from 0.01 to 2% by weight, preferably from 0.02 to 1% by weight, and in particular from 0.02 to 0.5% by weight of at least one, especially one, organic amine and/or ammonia as constituent (C). The amine (C) is preferably selected from the group of the tertiary amines, preferably of the tertiary alkylamines, and in particular the tertiary hydroxyalkylamines. Examples of suitable tertiary hydroxyalkylamines are triethanolamine, methyldiethanolamine and dimethylethanolamine, especially dimethyl-ethanolamine.

The pigment pastes of the invention further contain, based on their total amount, from 0.1 to 3% by weight, preferably from 0.2 to 2% by weight, and in particular from 0.2 to 1% by weight of at least one, especially one, nonionic surfactant. Suitable nonionic surfactants or “niosurfactants” (cf. Römpp Lexikon Lacke und Druckfarben, Georg Thieme Verlag, 1998, page 410, “niosurfactants”) in accordance with the invention include surfactants whose hydrophilicity is established by means of polyether chains, hydroxyl groups, carboxamido groups, urethane groups and/or ester groups. Nonionic surfactants are commercial products and are sold, for example, under the brand name Tegodispers® 740 by Tego or under the brand name Hydropalat® 3037 by Cognis Preference is given to using Tegodispers® 740 and Hydropalat® 3037 Hydropalat® 3037 is a silicone-free surface-active leveling additive for aqueous systems, having a hydroxyl number of from 73 to 83 mg KOH/g and a hydrolysis number (DGF C-V 3) of from 56 to 62. Tegodispers® 740 is a nonionic, modified fatty acid derivative which is free from aromatics, from amine and from nonylphenol ethoxylate.

The pigment pastes of the invention contain not least, based on their total amount, at least 10% by weight, preferably at least 20% by weight, and in particular at least 40% by weight of an organic solvent, such as are commonly used in the field of coating materials Examples of suitable solvents are known from the book by Dieter Stoye and Werner Freitag (editors), “Paints, Coatings and Solvents”, second, completely revised edition, Wiley-VCH, Weinheim, New York, 1998, pages 327 to 373.

The pigment pastes of the invention preferably contain water in an amount of from 0.5 to 20% by weight, more preferably from 1 to 15% by weight, and in particular from 2 to 10% by weight, based in each case on a pigment paste of the invention.

The pigment pastes of the invention may further comprise conventional additives, such as are described, for example, in the textbook by Johan Bieleman, “Lackadditive [Additives for Coatings]”, Wiley-VCH, Weinheim, New York, 1998. It is, however, a particular advantage of the pigment pastes of the invention that they need not include any further additives in order to achieve the advantages according to the invention.

The preparation of the pigment pastes of the invention requires no peculiarities of method but instead takes place in accordance with the conventional methods of preparing pigment pastes or pigment formulations by mixing of the above-described constituents in suitable mixing equipment such as stirred tanks, dissolvers, Ultraturrax devices, in-line dissolvers, mills with a stirrer mechanism, bead mills or extruders. The skilled worker, on the basis of his or her general art knowledge, is able to select the techniques and apparatus such that the particular effect pigments (A) being dispersed are not damaged.

The pigment pastes (A) of the invention can be used for preparing a very wide variety of pigmented mixtures. In particular the pigment pastes of the invention are used for preparing aqueous or nonaqueous effect, or color and effect, coating materials, preferably aqueous coating materials, especially waterborne basecoat materials.

For this purpose the pigment pastes of the invention are mixed in the requisite amount with the other ingredients of the respective pigmented mixtures, preferably of the aqueous or nonaqueous coating materials, more preferably of the aqueous coating materials, and in particular of the waterborne basecoat materials, and then the resulting mixtures are homogenized. For this purpose it is preferred to use the techniques and apparatus described above.

Examples of suitable ingredients are water-soluble and/or water-dispersible polymeric and oligomeric binders and also those soluble and/or dispersible in organic solvents. The binders are preferably selected from the group consisting of random, alternating, and block, linear, branched, and comb addition (co)polymers of ethylenically unsaturated monomers, polyadditon resins, and polycondensation resins. Regarding these terms refer to Römpp Lexikon Lacke und Druckfarben, Georg Thieme Verlag, Stuttgart, New York, 1998, page 457, “polyaddition” and “polyaddition resins (polyadducts)”, and pages 463 and 464, “polycondensates”, “polycondensation”, and “polycondensation resins”, and also pages 73 and 74, “binders”.

The addition (co)polymers are preferably selected from the group consisting of (meth)acrylate (co)polymers and partially hydrolyzed polyvinyl esters, especially (meth)acrylate copolymers, and the polyaddition resins and polycondensation resins from the group consisting of polyesters, alkyds, polyurethanes, polylactones, polycarbonates, polyethers, epoxy resin-amine adducts, polyureas, polyamides, polyimides, polyester-polyurethanes, polyether-polyurethanes, and polyester-polyether polyurethanes, especially polyester-polyurethanes.

Very particular preference is given to using the binders as used in conventional waterborne basecoat materials. Binders of this kind are described for example in German patent application DE 196 52 842 A1, column 2 line 53 to column 3 line 46, and in German patent application DE 199 14 896 A1, column 5 line 34 to column 11 line 5.

Further examples of suitable ingredients are conventional crosslinking agents and additives, such as are described, for example, in German patent application DE 199 14 896 A1, column 11 line 6 to column 16 line 16.

Further examples of suitable ingredients are the color pigments described above.

The resulting pigmented mixtures, preferably the aqueous or nonaqueous coating materials, more preferably the aqueous coating materials, and in particular the waterborne basecoat materials can be curable physically, thermally with internal and/or external crosslinking, with actinic radiation, or both thermally and with actinic radiation. By actinic radiation is meant near infrared (NIR), visible light, UV radiation, X-rays or gamma radiation, especially UV radiation, and also corpuscular radiation, such as alpha radiation, beta radiation, neutron beams or electron beams, especially electron beams. Joint thermal curing and curing with actinic radiation is referred to by those in the art as dual cure.

The pigmented mixtures, preferably the aqueous or nonaqueous coating materials, more preferably the aqueous coating materials, and in particular the waterborne basecoat materials are preferably used for producing effect or color and effect coatings and coating systems which are decorative, protect against mechanical damage, inhibit corrosion, are magnetically shielding, are electrically conductive and/or have signal functions, especially optical effect, and color and optical effect, coatings and coating systems, on substrates of all kinds.

Suitable substrates include all surfaces to be coated or painted which are not damaged by curing of the coating materials applied thereon using heat or both heat and actinic radiation. Suitable substrates consist for example of metals, plastics, wood, ceramic, stone, textile, fiber composites, leather, glass, glass fibers, glass wool and rock wool, mineral-bound and resin-bound building materials, such as plasterboard and cement slabs or roofing shingles, and also composites of these materials. The surfaces of these materials may already have been prepainted or precoated.

Accordingly, pigmented mixtures, especially the coating materials, are outstandingly suitable for the coating or painting of bodies of means of transport of any kind (especially means of transport operated with muscle power, such as cycles, carriages or railroad trolleys, aircraft, such as airplanes or airships, floating structures, such as ships or buoys, rail vehicles, and motor vehicles, such as motorcycles, buses, trucks or automobiles) or of parts thereof; of the interior and exterior of constructions; of furniture, windows, and doors; of small industrial parts, of coils, containers, and packaging; of white goods; of sheets; of optical, electrical, and mechanical components, and also of hollow glassware.

In particular, however, the coating materials, and especially the waterborne basecoat materials, are suitable for producing original finishes (OEM) and refinishes on motor vehicles, especially automobiles. In this context the waterborne basecoat materials serve in particular to produce the basecoats of multicoat effect, or color and effect, paint systems.

The multicoat paint systems can be produced in a variety of ways. Preference is given to using the wet-on-wet techniques described in German patent application DE 199 30 664 A1, page 15 lines 36 to 58, or in German patent application DE 199 14 896 A1, column 2 line 15 to column 3 line 24 and column 16 line 54 to column 18 line 54. This is done using the conventional techniques and apparatus for the application and curing of coating materials, especially aqueous coating materials.

Owing to the outstanding distribution of the effect pigments (A) in the pigment pastes of the invention and their outstanding storage stability, the ultimate coatings and paint systems, especially multicoat paint systems, are of outstanding stability of shade and stability of optical effects. The multicoat paint systems can therefore be used with advantage for the OEM finishing and refinish of top-class automobiles.

### EXAMPLES

### Preparation Example 1

### Preparation of a Pigment-free Mixture of Conventional Ingredients of Waterborne Basecoat Materials

57.4 parts by weight of an aqueous polyurethane dispersion such as is commonly used for preparing waterborne basecoat materials were mixed with 12.3 parts by weight of a melamine-formaldehyde resin (crosslinking agent) such as is commonly used for preparing waterborne basecoat materials and with 1.8 parts by weight of a methacrylate copolymer such as is commonly used for preparing waterborne basecoat materials. This mixture was admixed with a total of 6 parts by weight of conventional waterborne basecoat additives, 1 part by weight of a commercial flatting paste, and 3 parts by weight of a talc paste. Finally 4.5 parts by weight of water and 0.5 part by weight of a conventional polyurethane thickener were added, after which the resulting mixture was homogenized.

### Example 1

### Preparation of an Aluminum Effect Pigment Paste

First 52 parts by weight of water were mixed with 0.5 part by weight of Hydropalat® 3037 (commercial nonionic surfactant from Cognis). Then 37.5 parts by weight of a commercial aluminum effect pigment were added. Subsequently 10 parts by weight of Setalux® 6802 AQ 24 (commercial aqueous primary dispersion from Akzo) were added. This mixture was admixed with 0.5 part by weight of 10% strength dimethylethanolamine solution for the purpose of neutralization. The entire mixture was subsequently homogenized for 20 minutes.

The transportability of the resulting pigment paste was very good and it had a storage stability of several months without tending to settle. Even on prolonged storage it showed no gassing or any reduction in metallic effect.

### Example 2

### Preparation of a Waterborne Basecoat Material

12 parts by weight of the pigment paste from example 1 were added to 86 parts by weight of the pigment-free mixture from preparation example 1, after which the two ingredients were carefully mixed, with the addition of 2 parts by weight of water.

The transportability of the resultant waterborne basecoat material was very good and it displayed an outstanding storage stability. Owing to the outstanding orientation of the aluminum effect pigments, the basecoats produced therefrom displayed an outstanding and particularly pronounced metallic effect. The waterborne basecoat material was therefore especially suitable for the production of multicoat effect paint systems for top-class automobiles.

1. An effect pigment paste prepared from at least the following constituents:
(A) from 10 to 65% by weight of at least one effect pigment,
(B) from 1 to 20% by weight of at least one aqueous monomodal primary dispersion which is pseudoplastic after neutralization and has a solids content of from 15 to 40% by weight, comprising as disperse phase particles with an average size of from 10 to 500 nm which are composed of a hydrophobic core and hydrophilic shell, said particles being constructed of at least one (meth)acrylate copolymer having a glass transition temperature of from 30 to 100° C. and an acid number of from 10 to 50 mg KOH/g,
(C) from 0.01 to 2% by weight of at least one organic amine and/or ammonia,
(D) from 0.1 to 3.0% by weight of at least one nonionic surfactant, and
(E) at least 10% by weight of an organic solvent,
the percentages being based in each case on the total amount of a pigment paste.

2. The pigment paste as claimed in claim 1, wherein the (meth)acrylate copolymer of the primary dispersion (B) has a glass transition temperature Tg between 40 to 90° C.

3. The pigment paste as claimed in claim 1, wherein the particles of the primary dispersion have a size of from 100 to 300 nm.

4. The pigment paste as claimed in claim 1, wherein the (meth)acrylate copolymer of the primary dispersion (B) contains in copolymerized form (meth)acrylates selected from the group consisting of methyl methacrylate, n-butyl acrylate, hydroxyethyl methacrylate, n-butyl methacrylate, acrylic acid, and methacrylic acid.

5. The pigment paste as claimed in claim 1, wherein the effect pigment (A) is selected from the group consisting of organic, inorganic, optical effect, color and optical effect, magnetically shielding, electrically conductive, anticorrosion, fluorescent, and phosphorescent pigments.

6. The pigment paste as claimed in claim 5, wherein the effect pigment (A) is selected from the group consisting of organic, inorganic, optical effect, and color and optical effect pigments.

7. The pigment paste as claimed in claim 6, wherein the effect pigment (A) is selected from the group consisting of metal effect pigments, effect pigments composed of metals and nonmetals, and nonmetallic effect pigments.

8. The pigment paste as claimed in claim 7, wherein the metal effect pigment (A) is selected from the group consisting of aluminum effect pigments, iron effect pigments, and copper effect pigments, the effect pigments (A) composed of metals and nonmetals are selected from the group consisting of platelet-shaped aluminum pigments coated with iron oxide, glass flakes coated with metals, and interference pigments which comprise a reflector layer of metal and exhibit a strong color flop, and the nonmetallic effect pigments (A) are selected from the group consisting of pearlescent pigments, platelet-shaped graphite pigments coated with metal oxides, interference pigments which do not contain a metal reflector layer but exhibit a strong color flop, platelet-shaped effect pigments based on iron oxide with a shade ranging from pink to brownish red, and organic, liquid-crystalline effect pigments.

9. The pigment paste as claimed in claim 1, comprising at least one pigment selected from the group consisting of organic color pigments, inorganic color pigments, fillers, and nanoparticles.

10. The pigment paste as claimed in claim 1, containing from 0.5 to 20% by weight of water.

11. A process for preparing an effect pigment paste as claimed in claim 1, which comprises mixing
(A) from 10 to 65% by weight of at least one effect pigment,
(B) from 1 to 20% by weight of at least one aqueous monomodal primary dispersion which is pseudoplastic after neutralization and has a solids content of from 15 to 40% by weight, comprising as disperse phase particles with an average size of from 10 to 500 nm which are composed of a hydrophobic core and hydrophilic shell, said particles being constructed of at least one (meth)acrylate copolymer having a glass transition temperature of from 30 to 100° C. and an acid number of from 10 to 50 mg KOH/g,
(C) from 0.01 to 2% by weight of at least one of organic amine or ammonia,
(D) from 0.1 to 3.0% by weight of at least one nonionic surfactant, and
(E) at least 10% by weight of an organic solvent,
the percentages being based in each case on the total amount of a pigment paste, with one another and homogenizing the resultant mixture.

12. A pigmented mixture comprising the effect pigment paste as claimed in claim 1.

13. A pigmented mixtures as claimed in to claim 12 comprising at least one of aqueous or nonaqueous coating materials.

14. The aqueous coating materials as claimed in claim 13 comprising waterborne basecoat materials.

15-17. (canceled)
